(19) United States
(12) Patent Application Publication
(10) Pub. No.: US 2013/0148242 A1
(43) Pub. Date: Jun. 13, 2013

(54) MAGNETIC RECORDING HEAD AND DISK DRIVE WITH THE SAME

(71) Applicants: Katsuhiko KOUI, Yokohama-shi (JP); Mariko KITAZAKI, Kawasaki-shi (JP); Shuichi MURAKAMI, Tokyo (JP); Kenichiro YAMADA, Tokyo (JP)

(72) Inventors: Katsuhiko KOUI, Yokohama-shi (JP); Mariko KITAZAKI, Kawasaki-shi (JP); Shuichi MURAKAMI, Tokyo (JP); Kenichiro YAMADA, Tokyo (JP)

(73) Assignee: KABUSHIKI KAISHA TOSHIBA, Tokyo (JP)

(21) Appl. No.: 13/585,316

(22) Filed: Aug. 14, 2012

(30) Foreign Application Priority Data
Dec. 7, 2011 (JP) 2011-268213

(51) Int. Cl. G11B 5/127

(52) U.S. Cl. 360/125.12; 977/700; G9B/5.04

(57) ABSTRACT

According to one embodiment, a magnetic recording head includes a spin-torque oscillator between a main pole and a trailing shield. An oscillation layer of the spin-torque oscillator is formed by repeatedly stacking two or more laminates each including a metallic magnetic layer of a body-centered cubic crystalline metal and a metallic magnetic layer containing cobalt. The film thickness of each metallic magnetic layer is more than 0.2 nm and not more than 3 nm. The intensity of an anisotropic magnetic field is higher than a value obtained by subtracting the intensity of a gap magnetic field from the intensity of a diamagnetic field and lower than the intensity of the diamagnetic field.

### CROSS-REFERENCE TO RELATED APPLICATIONS

This application is based upon and claims the benefit of priority from prior Japanese Patent Application No. 2011-268213, filed Dec. 7, 2011; the entire contents of which are incorporated herein by reference.

### FIELD

Embodiments described herein relate generally to a magnetic recording head and a disk drive with the same.

### BACKGROUND

A magnetic recording device, such as a magnetic disk drive, comprises a magnetic disk, spindle motor, magnetic head, and carriage assembly, which are disposed in a case. The spindle motor supports and rotates the magnetic disk. The magnetic head reads data from and writes data to the magnetic disk. The carriage assembly supports the magnetic head for movement relative to the magnetic disk. A head section of the magnetic head comprises a recording head for writing and a read head for reading.

Magnetic heads for perpendicular magnetic recording have recently been proposed in order to increase the recording density and capacity of a magnetic disk drive or reduce its size. In one such magnetic head, a recording head comprises a main pole configured to produce a perpendicular magnetic field, trailing shield, and coil. The trailing shield is located on the trailing side of the main pole with a write gap therebetween. The coil serves to pass magnetic flux through the main pole.

To improve the recording density, a magnetic head based on high-frequency magnetic field assisted recording is proposed in which a spin-torque oscillator for use as a high-frequency oscillation element is disposed between the main pole and the trailing shield.

A microwave-assisted magnetic recording head is configured so that the oscillation frequency is improved by applying a gap magnetic field perpendicular to the film plane of the spin-torque oscillator formed in the write gap. Normally, the intensity of the gap magnetic field ranges from approximately 8 to 12 kOe. When the oscillation layer of the spin-torque oscillator is being actively rotated by spin torque, a diamagnetic field in the oscillation layer is reduced. Therefore, most of magnetic fields that effectively act on the oscillation layer approach the gap magnetic field. At this point in time, the oscillation frequency reaches approximately 20 to 30 GHz, based on the principle of ferromagnetic resonance. This frequency band is optimal for recording on magnetic recording media with anisotropic magnetic fields of up to approximately 20 kOe.

In order to increase the assist effect, on the other hand, the high-frequency magnetic field intensity must be increased. To attain this, the magnetic volume of the oscillation layer must be increased. The magnetic volume of the oscillation layer can be increased by using a high-flux-density (Bs) material for the oscillation layer or increasing the film thickness. According to the method for increasing the film thickness, however, the linear recording resolution is degraded by extension of the write gap. Preferably, therefore, the magnetic volume should be increased by using a high-Bs material.

If a high-Bs material such as an Fe—Co alloy with Bs higher than 2T is selected as a conventional oscillation layer material, however, the diamagnetic field of the oscillation layer is so large that the direction of magnetization is inclined in-plane even in the gap magnetic field. In this magnetization direction, the frequency is too low to achieve stable high-frequency oscillation despite the supply of spin-torque oscillatory current. Thus, in enhancing a high-frequency magnetic field, it is difficult to achieve stable high-frequency oscillation.

### BRIEF DESCRIPTION OF THE DRAWINGS

FIG. 1 is a perspective view showing a magnetic disk drive (HDD) according to a first embodiment;

FIG. 2 is a side view showing a magnetic head and suspension of the HDD;

FIG. 3 is an enlarged sectional view showing a head section of the magnetic head;

FIG. 4 is an enlarged sectional view showing the disk-side end portion of the recording head;

FIG. 5 is a plan view of the recording head taken from the ABS side of a slider;

FIG. 6 is a sectional view schematically showing a spin-torque oscillator of the recording head;

FIG. 7 is an enlarged sectional view showing the spin-torque oscillator of the recording head and its surroundings;

FIG. 8 is a diagram comparatively showing magnetic field-oscillation frequency characteristics of the recording heads according to the present embodiment and a comparative example;

FIG. 9 is a diagram showing configurations of oscillation layers of Examples 1 to 7 of the present embodiment and comparative examples 1 to 5;

FIG. 10 is a diagram comparatively showing relationships between the supplied recording currents and oscillation frequencies for examples 1 to 7 and Comparative Examples 1 to 5; and

FIG. 11 is a diagram showing directions of magnetization of oscillation layers of examples 1 to 7 and comparative examples 1 to 5 produced when recording currents are supplied.

### DETAILED DESCRIPTION

Various embodiments will be described hereinafter with reference to the accompanying drawings. In general, according to one embodiment, a magnetic recording head comprises: a main pole configured to apply a recording magnetic field; a trailing shield opposite the main pole with a write gap therebetween; a spin-torque oscillator between the main pole and the trailing shield and configured to produce a high-frequency magnetic field; and a power supply configured to supply current to the spin-torque oscillator. The spin-torque oscillator comprises a spin injection layer, an interlayer, and an oscillation layer. The oscillation layer is formed by repeatedly stacking two or more laminates each comprising a metallic magnetic layer of a body-centered cubic crystalline metal and a metallic magnetic layer containing cobalt such that the film thickness of each of the metallic magnetic layers is more than 0.2 nm and not more than 3 nm. The intensity of an anisotropic magnetic field perpendicular to the film plane of the oscillation layer is higher than a value obtained by subtracting the intensity of a gap magnetic field from the intensity of a diamagnetic field perpendicular to the film plane of the oscillation layer and lower than the intensity of the diamagnetic field.

### FIRST EMBODIMENT

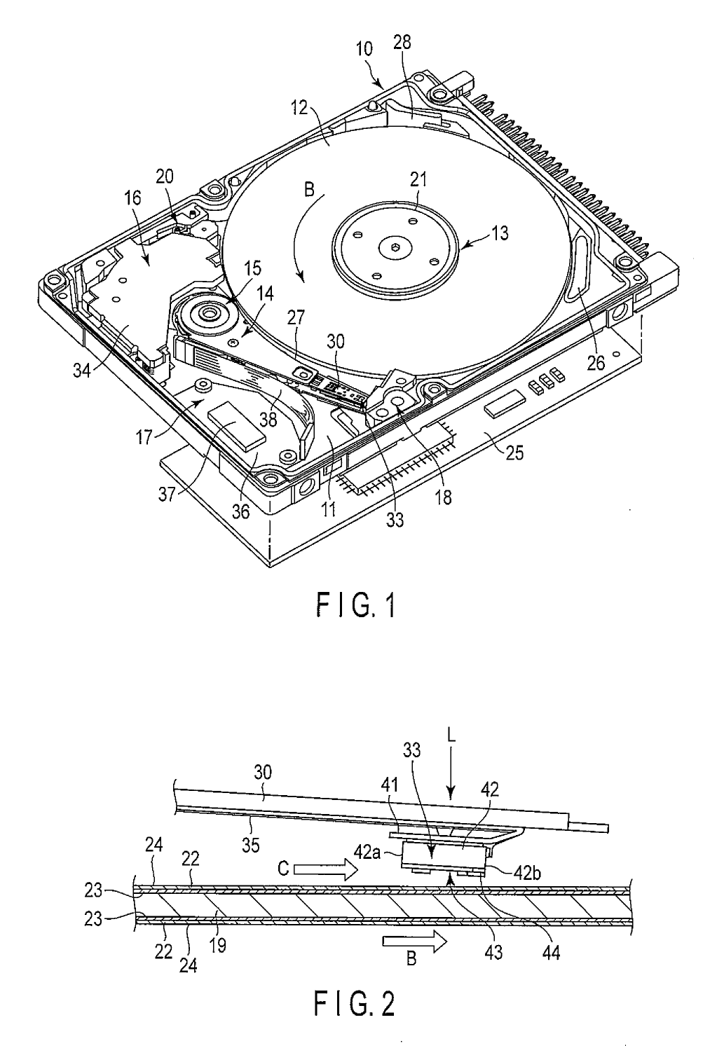

FIG. 1 shows the internal structure of an HDD as a magnetic recording device comprising a magnetic recording head, with its top cover removed, and FIG. 2 shows a flying magnetic head. As shown in FIG. 1, the HDD comprises a housing 10. The housing 10 comprises a base 11 in the form of an open-topped rectangular box and a top cover (not shown) in the form of a rectangular plate. The top cover is attached to the base by screws such that it closes the top opening of the base. Thus, the housing 10 is kept airtight inside and can be ventilated through a breather filter 26.

The base 11 carries thereon a magnetic disk 12, for use as a recording medium, and a drive section. The drive section comprises a spindle motor 13, a plurality (e.g., two) of magnetic heads 33, head actuator 14, and voice coil motor (VCM) 16. The spindle motor 13 supports and rotates the magnetic disk 12. The magnetic heads 33 record and reproduce data on and from the disk 12. The head actuator 14 supports the heads 33 for movement relative to the surfaces of the disk 12. The VCM 16 pivots and positions the head actuator. The base 11 further carries a ramp loading mechanism 18, inertial latch 20, and board unit 17. The ramp loading mechanism 18 holds the magnetic heads 33 in a position off the magnetic disk 12 when the heads are moved to the outermost periphery of the disk. The inertial latch 20 holds the head actuator 14 in a retracted position if the HDD is jolted, for example. Electronic components, such as a preamplifier, head IC, etc., are mounted on the board unit 17.

A control circuit board 25 is attached to the outer surface of the base 11 by screws such that it faces a bottom wall of the base. The circuit board 25 controls the operations of the spindle motor 13, VCM 16, and magnetic heads 33 through the board unit 17.

As shown in FIGS. 1 and 2, the magnetic disk 12 is constructed as a perpendicular magnetic recording film medium. The magnetic disk 12 comprises a substrate 19 formed of a nonmagnetic disk with a diameter of, for example, approximately 2.5 inches. A soft magnetic layer 23 for use as an underlayer is formed on each surface of the substrate 19. The soft magnetic layer 23 is overlain by a perpendicular magnetic recording layer 22, which has a magnetic anisotropy perpendicular to the disk surface. Further, a protective film 24 is formed on the recording layer 22.

As shown in FIG. 1, the magnetic disk 12 is coaxially fitted on the hub of the spindle motor 13 and clamped and secured to the hub by a clamp spring 21, which is attached to the upper end of the hub by screws. The disk 12 is rotated at a predetermined speed in the direction of arrow B by the spindle motor 13 for use as a drive motor.

The head actuator 14 comprises a bearing 15 secured to the bottom wall of the base 11 and a plurality of arms 27 extending from the bearing. The arms 27 are arranged parallel to the surfaces of the magnetic disk 12 and at predetermined intervals and extend in the same direction from the bearing 15. The head actuator 14 comprises elastically deformable suspensions 30 each in the form of an elongated plate. Each suspension 30 is formed of a plate spring, the proximal end of which is secured to the distal end of its corresponding arm 27 by spot welding or adhesive bonding and which extends from the arm. Each magnetic head 33 is supported on the extended end of its corresponding suspension 30 by a gimbal spring 41. Each suspension 30, gimbal spring 41, and magnetic head 33 constitute a head gimbal assembly.

As shown in FIG. 2, each magnetic head 33 comprises a substantially cuboid slider 42 and read/write head section 44 on an outflow end (trailing end) of the slider. A head load L directed to the surface of the magnetic disk 12 is applied to each head 33 by the elasticity of the suspension 30. The two arms 27 are arranged parallel to and spaced apart from each other, and the suspensions 30 and heads 33 mounted on these arms face one another with the magnetic disk 12 between them.

Each magnetic head 33 is electrically connected to a main flexible printed circuit 38 (described later) through a relay FPC 35 secured to the suspension 30 and arm 27.

As shown in FIG. 1, the board unit 17 comprises an FPC main body 36 formed of a flexible printed circuit board and the main FPC 38 extending from the FPC main body. The FPC main body 36 is secured to the bottom surface of the base 11. The electronic components, including a preamplifier 37 and head IC, are mounted on the FPC main body 36. An extended end of the main FPC 38 is connected to the head actuator 14 and also connected to each magnetic head 33 through each relay FPC 35.

The VCM 16 comprises a support frame (not shown) extending from the bearing 15 in the direction opposite to the arms 27 and a voice coil supported on the support frame. When the head actuator 14 is assembled to the base 11, the voice coil is located between a pair of yokes 34 that are secured to the base 11. Thus, the voice coil, along with the yokes and a magnet secured to the yokes, constitutes the VCM 16.

If the voice coil of the VCM 16 is energized with the magnetic disk 12 rotating, the head actuator 14 pivots, whereupon each magnetic head 33 is moved to and positioned on a desired track of the disk 12. As this is done, the head 33 is moved radially relative to the disk 12 between the inner and outer peripheral edges of the disk.

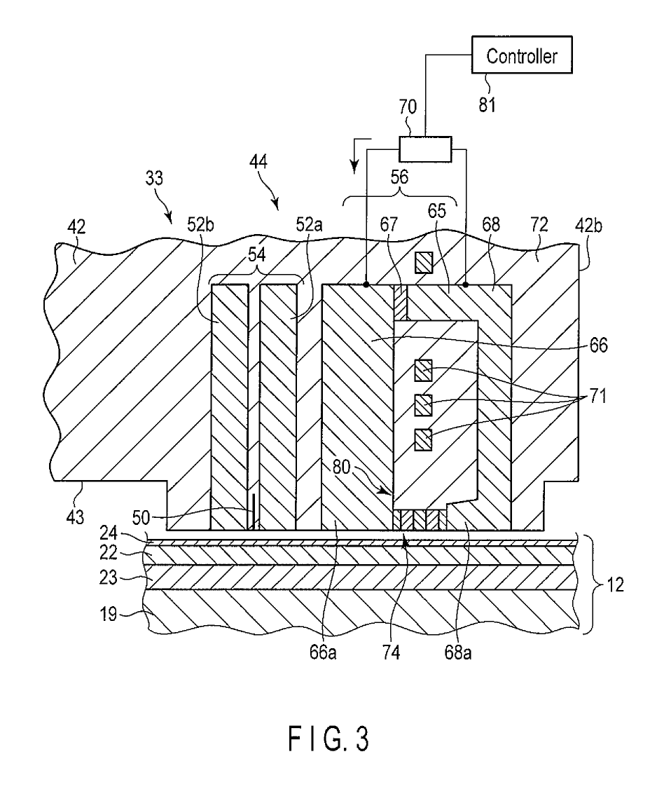

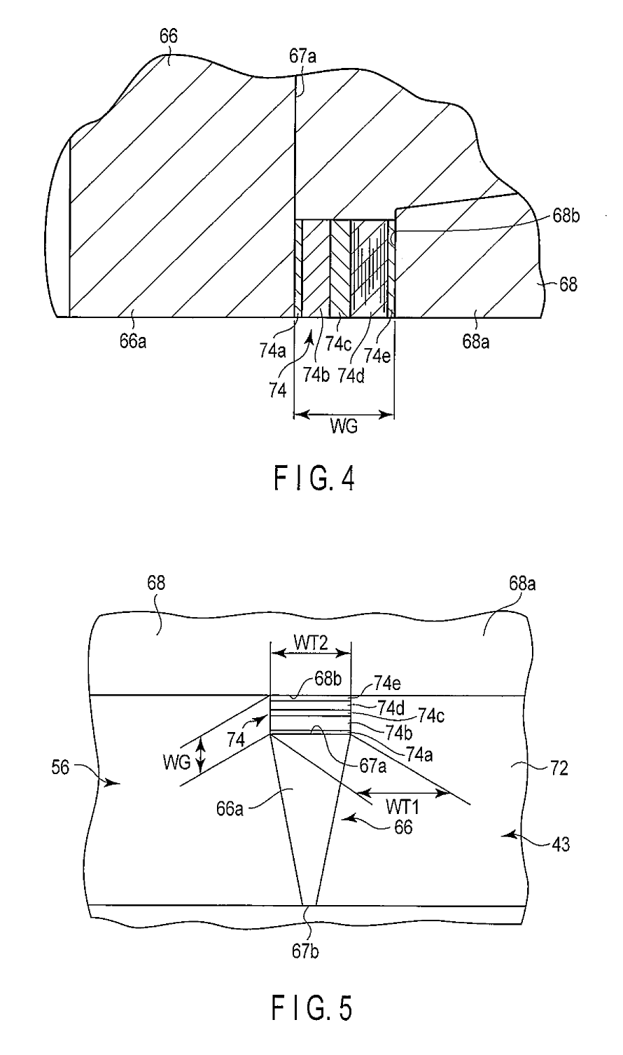

The following is a detailed description of a configuration of each magnetic head 33. FIG. 3 is an enlarged sectional view showing the head section 44 of the magnetic head 33, FIG. 4 is an enlarged sectional view showing the disk-side end portion of the magnetic recording head, and FIG. 5 is a plan view of the magnetic recording head taken from the ABS side of a slider.

As shown in FIGS. 2 and 3, the magnetic head 33 is constructed as a flying head, which comprises the substantially cuboid slider 42 and head section 44 formed on the outflow or trailing end of the slider. The slider 42 is formed of, for example, a sintered body (AlTic) containing alumina and titanium carbide, and the head section 44 is a thin film. The slider 42 has a rectangular disk-facing surface or air-bearing surface (ABS) 43 configured to face a surface of the magnetic disk 12. The slider 42 is caused to fly by airflow C that is produced between the disk surface and the ABS 43 as the disk 12 rotates. The direction of airflow C is coincident with the direction of rotation B of the disk 12. The slider 42 is disposed on the surface of the disk 12 in such a manner that the longitudinal direction of the ABS 43 is substantially coincident with the direction of airflow C.

The slider 42 comprises leading and trailing ends 42a and 42b on the inflow and outflow sides, respectively, of airflow C. The ABS 43 of the slider 42 is formed with leading and trailing steps, side steps, negative-pressure cavity, etc., which are not shown.

As shown in FIGS. 3 and 4, the head section 44 is constructed as a dual-element magnetic head, comprising a read head 54 and magnetic recording head 56 formed on the trailing end 42b of the slider 42 by thin-film processing.

The read head 54 comprises a magnetic film 50 exhibiting the magnetoresistive effect and shielding films 52a and 52b disposed on the trailing and leading sides, respectively, of the magnetic film such that they sandwich the magnetic film between them. The respective lower ends of the magnetic film 50 and shielding films 52a and 52b are exposed in the ABS 43 of the slider 42.

The magnetic recording head 56 is located nearer to the trailing end 42b of the slider 42 than the read head 54. The recording head 56 comprises a main pole 66 of a high-saturation magnetization material, trailing shield (or return pole) 68, recording coil 71, and spin-torque oscillator 74 as a high-frequency oscillator. The main pole 66 produces a recording magnetic field perpendicular to the surfaces of the magnetic disk 12. The trailing shield 68 is located on the trailing side of the main pole 66 and serves to efficiently close a magnetic path through the soft magnetic layer 23 just below the main pole. The recording coil 71 is located so that it is wound around a magnetic circuit including the main pole 66 and trailing shield 68 to pass magnetic flux to the main pole while a signal is being recorded on the magnetic disk 12. The spin-torque oscillator 74 is disposed in magnetic gap WG between a distal end portion 66a of the main pole 66 and the trailing shield 68.

A power supply 70 is connected to the main pole 66 and trailing shield 68, and a current circuit is constructed such that current from the power supply can be supplied in series through the trailing shield.

The main pole 66 extends substantially perpendicular to the surfaces of the magnetic disk 12. The lower end part of the main pole 66 on the side of the magnetic disk 12 is tapered toward the magnetic disk so that its distal end portion 66a is in the form of a pillar narrower than the other portion. As shown in FIG. 5, the distal end portion 66a of the main pole 66 comprises a trailing-end surface 67a of a predetermined width, leading-end surface 67b, and opposite side surfaces. The trailing-end surface 67a has, for example, a trapezoidal cross-section and is located on the trailing-end side. The leading-end surface 67b is narrower than the trailing-end surface and is located opposite the same. The lower end surface of the main pole 66 is exposed in the ABS 43 of the slider 42. Width WT1 of the trailing-end surface 67a is substantially equal to the track width of the magnetic disk 12.

As shown in FIG. 3, the trailing shield 68 is substantially U-shaped and its distal end portion 68a has an elongated rectangular shape. The distal end surface of the trailing shield 68 is exposed in the ABS 43 of the slider 42. A leading-end surface 68b of the distal end portion 68a extends transversely relative to the track of the magnetic disk 12. The end surface 68b is opposed substantially parallel to a trailing-end surface 67a of the main pole 66 with write gap WG (e.g., 40 nm) therebetween.

The trailing shield 68 comprises a junction 65 located near the upper part of the main pole 66 in a position off the ABS 43 of the slider 42. The junction 65 is connected to the main pole 66 by a back gap portion 67 of an insulator, such as SiO₂. This insulator electrically insulates the main pole 66 and trailing shield 68 from each other. Thus, by forming the back gap portion 67 from the insulator, current from the power supply 70 can be efficiently supplied to the spin-torque oscillator 74 through the main pole 66 and trailing shield 68 that serve also as electrodes of the oscillator 74. Al₂O₃ may be used in place of SiO₂ for the insulator of the back gap portion 67.

As shown in FIGS. 3 to 5, the spin-torque oscillator 74 is interposed between the trailing-end surface 67a of the distal end portion 66a of the main pole 66 and the leading-end surface 68b of the trailing shield 68 and arranged parallel to these end surfaces. Thus, the oscillator 74 is positioned within width WT1 of the distal end portion of the main pole transversely relative to the track in write gap WG. Length WT2 of the oscillator 74 transversely relative to the track is equal to length WT1 of the trailing-end surface 67a of the main pole 66 transversely relative to the track.

As shown in FIGS. 4 to 6, the spin-torque oscillator 74 is formed by, for example, sequentially laminating an underlayer 74a, spin injection layer (second magnetic layer) 74b, interlayer 74c, oscillation layer (first magnetic layer) 74d, and cap layer (protective layer) 74e, from the side of the main pole 66 to the side of the trailing shield 68. The underlayer 74a is, for example, a Ta/Ru/Cu laminated film. The spin injection layer 74b is an artificial lattice film formed by stacking ten laminates each comprising 0.2-nm-thick cobalt and 0.6-nm-thick nickel films. The interlayer 74c is a copper film. The oscillation layer 74d is an Fe/Co magnetic film. The cap layer 74e is a Cu/Ru laminated film. Specifically, the underlayer 74a, spin injection layer 74b, interlayer 74c, oscillation layer 74d, and cap layer 74e are sequentially laminated parallel to the ABS 43 of the slider 42 or to the magnetic disk surface. All these layers extend perpendicular to the ABS. Patterning is performed so that the element size is, for example, 40 nm square. Further, the entire thickness of the spin-torque oscillator 74 in the layer-thickness direction corresponds to write gap WG. The underlayer 74a and cap layer 74e are connected to the main pole 66 and trailing shield 68, respectively, which serve also as electrodes. Both or one of the underlayer 74a and cap layer 74e may be omitted. In this case, the spin injection layer 74b and oscillation layer 74d of the oscillator 74 are connected directly to the main pole 66 and trailing shield 68, respectively.

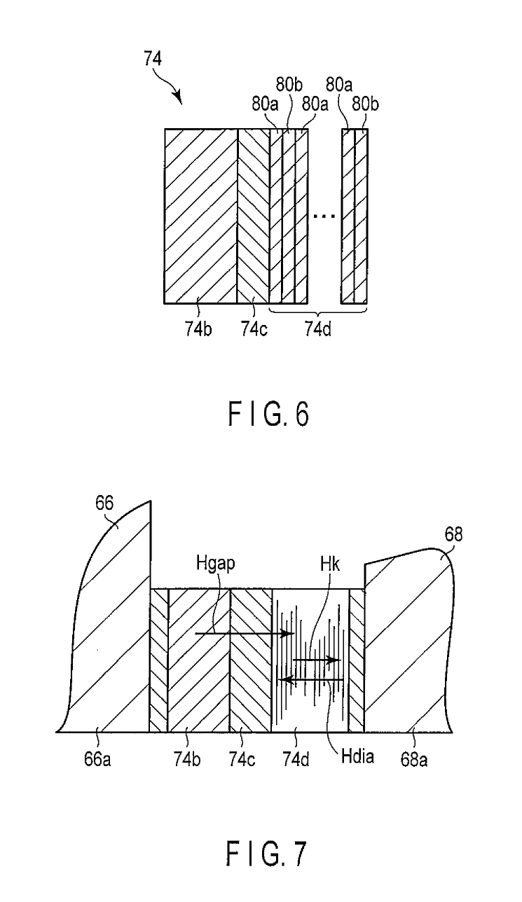

Preferably, the material of the oscillation layer 74d should be a soft magnetic material, e.g., an artificial lattice magnetic layer obtained by laminating cobalt-based metallic materials, such as Fe—Co—Al, Fe—Co/Ni, Fe/Ni, Fe/Co, etc., or an artificial lattice magnetic layer based on lamination of cobalt. In the present embodiment, as shown in FIG. 6, the oscillation layer 74d is formed by repeatedly stacking two or more laminates each comprising a metallic magnetic layer 80a of a body-centered cubic crystalline (bcc) metal and metallic magnetic layer 80b containing cobalt. The film thickness of each of the metallic magnetic layers 80a and 80b is more than 0.2 nm and not more than 3 nm. These laminates are sequentially stacked parallel to the ABS 43 of the slider 42 or to the magnetic disk surface. All these layers extend perpendicular to the ABS. For example, an iron or Fe—Co magnetic layer may be used for the metallic magnetic layer 80a.

A material with perpendicular magnetic anisotropy should preferably be used for the spin injection layer 74b. This is because the direction of magnetization must always be fixed along a gap magnetic field even under the reaction of spin torque or in a high-frequency magnetic field produced during oscillation of the oscillation layer 74d. Specifically, a material with high perpendicular magnetic anisotropy may be used as required. It may be selected from materials including Co—Cr-based magnetic layers, such as Co—Cr—Pt, Co—Cr—Ta, Co—Cr—Ta—Pt, and Co—Cr—Ta—Nb; rare earth (RE)-transition metal (TM)-based alloy magnetic layers, such as Tb-Fe—Co; artificial lattice magnetic layers of a cobalt-based alloy and alloys using palladium, platinum, nickel and other platinum group metals, such as Co/Pd, Co/Pt, Co—Cr—Ta/Pd, Co/Ni, Co/Ni—Pt, Fe—Co/Ni, and Fe—Co/Pt; Co—Pt— or Fe—Pt-based alloy magnetic layers; Sm—Co—based alloy magnetic layers, etc.

Further, the spin injection layer 74b need not always be formed only of a perpendicular magnetic anisotropic film. Even in the case where a soft magnetic layer is formed between the perpendicular magnetic anisotropic film and interlayer, the spin injection layer should only have sufficient perpendicular magnetic anisotropy in total. Specifically, by forming a material with a relatively high spin polarization ratio, satisfactory spin injection capability can be obtained without failing to maintaining the total perpendicular magnetic anisotropy. This material may be an approximately 2-nm-thick film of an Fe—Co alloy or an Fe—Co alloy doped with aluminum, silicon, gallium, germanium, copper, etc. The higher the perpendicular magnetic anisotropy, the more stable the spin injection capability is. If the perpendicular magnetic anisotropy is too high, however, it does not follow the reversal of the gap magnetic field, so that the oscillation becomes unstable. Preferably, therefore, the perpendicular magnetic anisotropy should be just high enough to be able to be reversed.

On the other hand, the perpendicular magnetic anisotropy of the spin injection layer 74b is applied for the purpose of standing the reaction from the oscillation layer 74d. In other words, the perpendicular magnetic anisotropy need not always be applied only if a reaction can be overcome by another method. Specifically, the main pole 66 or trailing shield 68 is positively bound to be magnetized in the direction of the gap magnetic field when recording current is supplied, and is not liable to be influenced by the reaction due to its large volume, so that it functions as the spin injection layer 74b.

To increase the spin torque, the interlayer 74c should preferably be formed from a material through which current easily flows. Specifically, this material may be a precious metal, such as copper, platinum, gold, silver, palladium, ruthenium, osmium, or iridium, or a nonmagnetic transition metal, such as chromium, rhodium, molybdenum, tungsten, aluminum, magnesium, Ni—Al, Al—Cu, or Au—Cu. Further, the interlayer 74c may be a current confinement structure of an alloy consisting of copper, silver, gold, nickel, iron, or cobalt and an insulator base material, such as alumina.

The materials and sizes of the oscillation layer 74d, spin injection layer 74b, and interlayer 74c are optionally selectable.

Although the spin injection layer 74b, interlayer 74c, and oscillation layer 74d are stacked in the order named, the oscillation layer, interlayer, and spin injection layer may alternatively be stacked in this order. In this case, the distance between the main pole 66 and oscillation layer 74d is reduced, so that a range in which a recording magnetic field produced by the main pole and a high-frequency magnetic field produced by the oscillation layer are efficiently superposed is enlarged over the medium, whereby satisfactory recording is enabled.

The spin-torque oscillator 74 has its distal end exposed in the ABS 43 and is disposed flush with the distal end surface of the main pole 66 with respect to the surface of the magnetic disk 12. As shown in FIG. 3, a protective insulating film 72 covers the entire area of the read head 54 and recording head 56 formed in the above-described manner except those parts which are exposed in the ABS 43 of the slider 42. The insulating film 72 forms the contour of the head section 44.

Under the control of the control circuit board 25, the spin-torque oscillator 74 is supplied with direct current along its film thickness as voltage from the power supply 70 is applied to the main pole 66 and trailing shield 68. By this current supply, the magnetization of the oscillation layer 74d of the oscillator 74 can be rotated to produce a high-frequency magnetic field. In this way, the high-frequency magnetic field is applied to the recording layer 22 of the magnetic disk 12. Thus, the main pole 66 and trailing shield 68 serve also as electrodes for perpendicular energization of the oscillator 74.

As shown in FIG. 7, the laminated structure (artificial lattice) formed by repeatedly stacking the bcc metallic magnetic layer 80a and the metallic magnetic layer 80b containing cobalt is used for the oscillation layer 74d. In this way, a high flux density (Bs, 2T or more) can be obtained by applying perpendicular anisotropic magnetic field Hk perpendicular to the film plane of the oscillation layer 74d, and in addition, magnetization can be oriented perpendicular to the film plane by gap magnetic field Hgap. Thus, the intensity of anisotropic magnetic field Hk perpendicular to the film plane of the oscillation layer 74d can be adjusted to a value greater than the difference between the respective intensities of diamagnetic field Hdia, which is produced in a direction perpendicular to the film plane of the oscillation layer 74d and opposite to gap magnetic field Hgap, and gap magnetic field Hgap, which occurs when the recording magnetic field is produced in the main pole 66, and lower than the intensity of diamagnetic field Hdia (Hdia>Hk).

If the spin injection layer 74b and oscillation layer 74d are magnetized in parallel relation after the magnetization of the oscillation layer 74d perpendicular to the film plane by gap magnetic field Hgap is achieved, torque from the spin injection layer functions most efficiently when current from the spin injection layer 74b is supplied to the oscillation layer 74d. Thereupon, the magnetization rotation of the oscillation layer 74d is highly enhanced, so that the frequency increases.

Thus, if the oscillation layer 74d is square with respect to the film in-plane direction, the magnetization of the oscillation layer 74d perpendicular to the film plane by gap magnetic field Hgap can be achieved when the sum of the respective intensities of perpendicular anisotropic magnetic field Hk and gap magnetic field Hgap is greater than a value obtained by subtracting half of magnetic flux density B from 1.5 times the intensity of diamagnetic field Hdia (1.5Hdia−0.5B<Hk+Hgap). If the oscillation layer 74d is rectangular with respect to the film in-plane direction, the intensity of field Hdia or Hgap must be higher than in the case of the square oscillation layer as the magnetization of the oscillation layer perpendicular to the film plane by gap magnetic field Hgap is achieved. However, the magnetization perpendicular to the film plane can be achieved if the sum of the intensities of perpendicular anisotropic magnetic field Hk and gap magnetic field Hgap is higher than that of diamagnetic field Hdia (Hdia<Hk+Hgap), at the least.

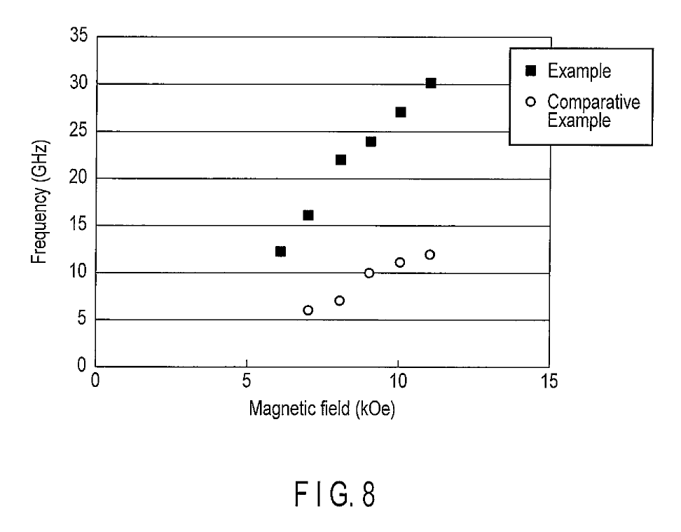

If the intensity of diamagnetic field Hdia of the oscillation layer 74d is so high that a parallel magnetization configuration by gap magnetic field Hgap cannot be obtained, in contrast, the efficiency of the torque from the spin injection layer 74b is reduced. Accordingly, the magnetization rotation of the oscillation layer 74d slackens, so that a proper oscillation frequency cannot be achieved. For this reason, the spin-torque oscillator 74 according to the present embodiment, compared with a comparative example in which an oscillation layer does not have magnetization anisotropy perpendicular to the film plane, can achieve a large high-frequency magnetic field while maintaining a high frequency, as shown in FIG. 8, if a current is supplied to the oscillator 74 to cause it to oscillate. Consequently, the microwave assist effect can be increased.

If the intensity of perpendicular anisotropic magnetic field Hk of the oscillation layer 74d is too high, the direction of magnetization of the oscillation layer is stabilized, so that the current for oscillation inevitably increases. If perpendicular anisotropic magnetic field Hk is so large that magnetization is oriented perpendicular to the film plane despite the absence of gap magnetic field Hgap, on the other hand, the spin injection layer 74b and oscillation layer 74d are approximately equivalent in magnetization stability. When current is supplied to the spin-torque oscillator 74, therefore, the magnetization stability on the injection side cannot be definitely distinguished from that on the oscillation side, and a mode occurs such that the magnetization finely oscillates on both sides. To avoid this, it is necessary to clearly define the difference in magnetization stability and definitely make the magnetization more unstable on the oscillation layer side than on the injection-layer side, by making such adjustment to prevent perpendicular anisotropic magnetic field Hk of the oscillation layer 74d from becoming too strong, as described above. Specifically, perpendicular anisotropic magnetic field Hk and diamagnetic field Hdia are balanced so that the direction of magnetization in the oscillation layer 74d is parallel to the film plane (in-plane) at least when gap magnetic field Hgap is not applied.

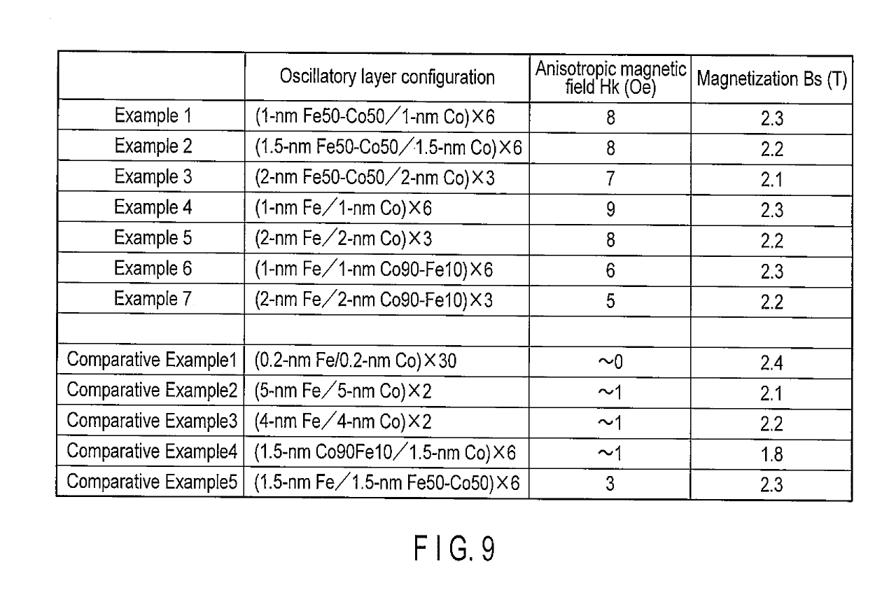

As shown in FIG. 9, spin-torque oscillators comprising oscillation layers 74d according to Examples 1 to 7 and Comparative Examples 1 to 5 were prepared and their magnetic properties were comparatively examined.

In Example 1, an oscillation layer 74d is formed by stacking six laminates each comprising a 1-nm-thick Fe50—Co50 layer and 1-nm-thick cobalt layer.

In Example 2, an oscillation layer 74d is formed by stacking six laminates each comprising a 1.5-nm-thick Fe50—Co50 layer and 1.5-nm-thick cobalt layer.

In Example 3, an oscillation layer 74d is formed by stacking three laminates each comprising a 2-nm-thick Fe50—Co50 layer and 2-nm-thick cobalt layer.

In Example 4, an oscillation layer 74d is formed by stacking six laminates each comprising a 1-nm-thick iron layer and 1-nm-thick cobalt layer.

In Example 5, an oscillation layer 74d is formed by stacking three laminates each comprising a 2-nm-thick iron layer and 2-nm-thick cobalt layer.

In Example 6, an oscillation layer 74d is formed by stacking six laminates each comprising a 1-nm-thick iron layer and 1-nm-thick Co90—Fe10 layer.

In Example 7, an oscillation layer 74d is formed by stacking three laminates each comprising a 2-nm-thick iron layer and 2-nm-thick Co90—Fe10 layer.

In Comparative Example 1, moreover, an oscillation layer 74d is formed by stacking 30 laminates each comprising a 0.2-nm-thick iron layer and 0.2-nm-thick cobalt layer.

In Comparative Example 2, an oscillation layer 74d is formed by stacking two laminates each comprising a 5-nm-thick iron layer and 5-nm-thick cobalt layer. In Comparative Example 3, an oscillation layer 74d is formed by stacking two laminates each comprising a 4-nm-thick iron layer and 4-nm-thick cobalt layer.

In Comparative Example 4, an oscillation layer 74d is formed by stacking six laminates each comprising a 1.5-nm-thick Co90—Fe10 layer and 1.5-nm-thick cobalt layer.

In Comparative Example 5, an oscillation layer 74d is formed by stacking six laminates each comprising a 1.5-nm-thick iron layer and 1.5-nm-thick Fe50—Co50 layer.

In Examples 1 to 7, as shown in FIG. 9, the oscillation layers have relatively high perpendicular magnetic anisotropy. In Comparative Examples 1 to 5, in contrast, the perpendicular magnetic anisotropy of the oscillation layers is very low. Based on the result of electron diffraction analysis for Examples 1 to 7, it was confirmed that a magnetic layer given on the left-hand side of each artificial lattice for each period has a bcc structure.

Based on the result of electron diffraction analysis for Comparative Example 4, on the other hand, it was confirmed that a magnetic layer given on the left-hand side of an artificial lattice for each period has a face-centered cubic crystal (fcc) structure. Thus, it can be seen that good perpendicular magnetic anisotropy for Examples 1 to 7 can be achieved by laminating metallic magnetic layers with the bcc structure.

In Comparative Example 1, artificial lattice periods are so fine that perpendicular magnetic anisotropy is lost. This is because characteristics for each magnetic layer are substantially lost and alloying characteristics have developed. In Comparative Examples 1 to 3, moreover, artificial lattice periods are so long that perpendicular magnetic anisotropy is lost. This is because average characteristics for each magnetic layer have developed and characteristics peculiar to the artificial lattice are lost. In Comparative Example 5, moreover, anisotropic magnetic field Hk is smaller than those of Examples 1 to 7. Based on the result of electron diffraction analysis, it was confirmed that a magnetic layer given on the left-hand side of the artificial lattice concerned for each period has the bcc structure. Based on the result of electron diffraction analysis, on the other hand, it was confirmed that a magnetic layer given on the right-hand side of the artificial lattice concerned for each period also has the bcc structure. Thus, it can be seen that good anisotropic magnetic field Hk cannot be easily obtained with the magnetic layers of the same bcc structure.

Oscillation characteristics were evaluated for recording heads comprising the spin-torque oscillators of Examples 1 to 7 and Comparative Examples 1 to 5. Drive current of 5 mA was supplied to the spin-torque oscillator 74 so that it flowed from the spin injection layer 74b toward the oscillation layer 74d. At the same time, recording current was supplied to the recording coil 71 to produce a gap magnetic field, and the oscillatory state of the oscillator 74 was observed. An electrical signal based on the giant magnetoresistive (GMR) effect of the oscillator 74 was captured by a spectrum analyzer to evaluate the measurement of the oscillation frequency.

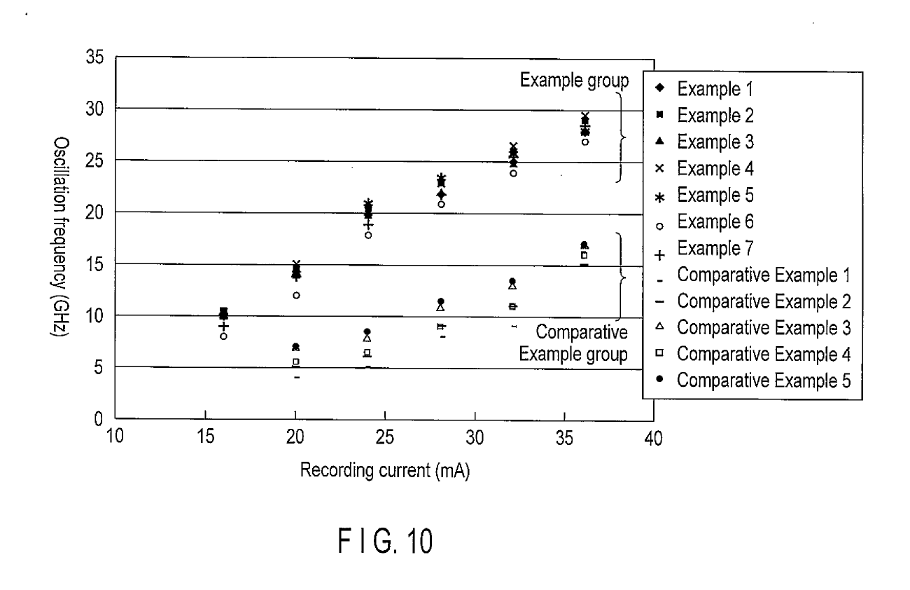

FIG. 10 shows the recording-current dependence of the oscillation frequency with respect to Examples 1 to 7 and Comparative Examples 1 to 5. In Examples 1 to 7 with relatively large perpendicular anisotropic magnetic field Hk, a necessary frequency of 20 GHz or more for microwave-assisted recording was able to be obtained. In Comparative Examples 1 to 5 with relatively small perpendicular anisotropic magnetic field Hk, in contrast, the oscillation frequency was not able to reach 20 GHz.

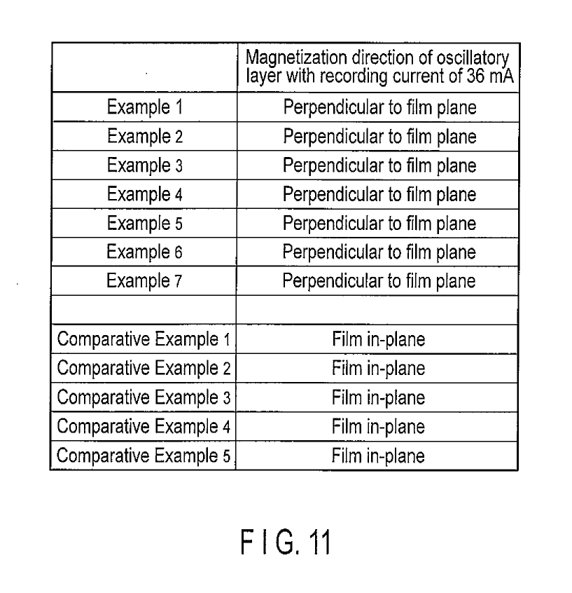

With respect to Examples 1 to 7 and Comparative Examples 1 to 5, the direction of magnetization of the oscillation layer 74d was determined by calculation for the case where the drive current of the spin-torque oscillator was zero. The magnetization direction of the oscillation layer 74d was estimated in consideration of the gap magnetic field, diamagnetic field of the oscillation layer, and magnetostatic coupling from the spin injection layer 74b. FIG. 11 shows the result of this estimation. In Examples 1 to 7, it can be seen that magnetization of the oscillation layer with which good high-frequency oscillation is achieved is perpendicular to the film plane. In Comparative Examples 1 to 5, it can be seen that magnetization of the oscillation layer is parallel to the film in-plane direction, that is, to the plane of each layer that constitutes the oscillation layer.

An oscillation operation was simulated and checked so that the above results can be theoretically explained. Consequently, it was indicated that the oscillation frequency was not increased by external application of a magnetic field in the case where the magnetization direction of the oscillation layer 74d was in-plane when the drive current of the spin-torque oscillator 74 was zero, as in Comparative Examples 1 to 5.

As in Examples 1 to 7, the oscillation layer 74d has a laminated structure (artificial lattice) such that the bcc metallic magnetic layer 80a and metallic magnetic layer 80b containing cobalt are repeatedly stacked and that the film thickness of each of these magnetic layers is more than 0.2 nm and not more than 3 nm. Further, the intensity of anisotropic magnetic field Hk of the oscillation layer 74d perpendicular to the film plane is higher than a value obtained by subtracting the intensity of gap magnetic field Hgap, which occurs when the recording magnetic field is produced in the main pole, from that of diamagnetic field Hdia (Hdia<Hk+Hgap) and lower than that of diamagnetic field (Hdia>Hk). Thus, it can be seen that the spin-torque oscillator 74 can achieve a large high-frequency magnetic field while maintaining a high frequency.

According to the magnetic recording head and HDD constructed in this manner, a strong high-frequency magnetic field can be produced without failing to maintaining a high frequency by the high-frequency oscillator, so that the microwave assist effect can be increased. Thus, magnetic recording can be achieved with higher density and precision.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the number of laminates each comprising the bcc metallic magnetic layer and magnetic layer containing cobalt, which constitute the oscillation layer, is not limited to the embodiment and Examples described herein and may be varied as required. The materials of the magnetic layers that constitute the spin-torque oscillators are not limited to the above embodiment and are optionally selectable.

What is claimed is:

1. A magnetic recording head comprising:
a main pole configured to apply a recording magnetic field;
a trailing shield opposite the main pole with a write gap between the main pole and the trailing shield;
a spin-torque oscillator between the main pole and the trailing shield, the spin-torque oscillator configured to produce a high-frequency magnetic field; and
a power supply configured to supply current to the spin-torque oscillator,
wherein the spin-torque oscillator comprises a spin injection layer, an interlayer, and an oscillation layer,
the oscillation layer comprises stacked laminates, each laminate comprising a metallic magnetic layer of a body-centered cubic crystalline metal and a metallic magnetic layer comprising cobalt, a film thickness of each of the metallic magnetic layers more than 0.2 nm and not more than 3 nm,
an intensity of an anisotropic magnetic field perpendicular to a film plane of the oscillation layer is higher than a first value and lower than an intensity of a diamagnetic field perpendicular to the film plane of the oscillation layer, the first value equaling a difference between an intensity of a gap magnetic field and the intensity of the diamagnetic field perpendicular to the film plane of the oscillation layer.

2. The magnetic recording head of claim 1, wherein the metallic magnetic layer of the body-centered cubic crystalline metal comprises mainly iron, and the metallic magnetic layer comprises mainly cobalt.

3. The magnetic recording head of claim 2, wherein the oscillation layer is configured so that a direction of magnetization of the oscillation layer is parallel to the film plane of the oscillation layer when no recording current flows to the magnetic recording head and the spin-torque oscillator is not supplied with current, and that the direction of magnetization of the oscillation layer is perpendicular to the film plane of the oscillation layer when the recording current flows to the magnetic recording head and the spin-torque oscillator is not supplied with current.

4. The magnetic recording head of claim 1, wherein the oscillation layer is configured so that a direction of magnetization of the oscillation layer is parallel to the film plane of the oscillation layer when no recording current flows to the magnetic recording head and the spin-torque oscillator is not supplied with current, and that the direction of magnetization of the oscillation layer is perpendicular to the film plane of the oscillation layer when the recording current flows to the magnetic recording head and the spin-torque oscillator is not supplied with current.

5. A magnetic recording device comprising:
a disk recording medium;
a drive unit configured to rotate the disk recording medium; and
a magnetic recording head configured to perform data processing on the disk recording medium, the magnetic recording head comprising:
a main pole configured to apply a recording magnetic field;
a trailing shield opposite the main pole with a write gap between the main pole and the trailing shield;
a spin-torque oscillator between the main pole and the trailing shield, the spin-torque oscillator configured to produce a high-frequency magnetic field; and
a power supply configured to supply current to the spin-torque oscillator,
wherein the spin-torque oscillator comprises a spin injection layer, an interlayer, and an oscillation layer,
the oscillation layer comprises stacked laminates, each laminate comprising a metallic magnetic layer of a body-centered cubic crystalline metal and a metallic magnetic layer comprising cobalt, a film thickness of each of the metallic magnetic layers more than 0.2 nm and not more than 3 nm,
an intensity of an anisotropic magnetic field perpendicular to a film plane of the oscillation layer is higher than a first value and lower than an intensity of a diamagnetic field perpendicular to the film plane of the oscillation layer, the first value equaling a difference between an intensity of a gap magnetic field and the intensity of the diamagnetic field perpendicular to the film plane of the oscillation layer.

6. The magnetic recording device of claim 5, wherein the metallic magnetic layer of the body-centered cubic crystalline metal comprises mainly iron, and the metallic magnetic layer comprises mainly cobalt.

7. The magnetic recording device of claim 6, wherein the oscillation layer is configured so that a direction of magnetization of the oscillation layer is parallel to the film plane of the oscillation layer when no recording current flows to the magnetic recording head and the spin-torque oscillator is not supplied with current, and that the direction of magnetization of the oscillation layer is perpendicular to the film plane of the oscillation layer when the recording current flows to the magnetic recording head and the spin-torque oscillator is not supplied with current.

8. The magnetic recording device of claim 5, wherein the oscillation layer is configured so that a direction of magnetization of the oscillation layer is parallel to the film plane of the oscillation layer when no recording current flows to the magnetic recording head and the spin-torque oscillator is not supplied with current, and that the direction of magnetization of the oscillation layer is perpendicular to the film plane of the oscillation layer when the recording current flows to the magnetic recording head and the spin-torque oscillator is not supplied with current.
